(19) United States
(12) Patent Application Publication
(10) Pub. No.: US 2016/0046474 A1
(43) Pub. Date: Feb. 18, 2016

(54) AMPOULE OPENER

(71) Applicant: St. John's University, New Taipei City (TW)

(72) Inventors: Po-Hsiang Liu, New Taipei City (TW); Ching-Wen Lien, New Taipei City (TW); Yu-Jen Lin, New Taipei City (TW)

(21) Appl. No.: 14/523,964

(22) Filed: Oct. 27, 2014

(30) Foreign Application Priority Data
Aug. 15, 2014 (TW) 103128181

(51) Int. Cl. B67B 7/92; F16B 2/14; F16B 2/06; A61J 1/06; A61J 1/16

(52) U.S. Cl. CPC B67B 7/92; A61J 1/065; A61J 1/16; F16B 2/06; F16B 2/14

(57) ABSTRACT

An ampoule opener is provided. The ampoule opener includes a clamping element and a cylindrical sleeve element. The clamping element includes a plurality of clamping arms. Each one of the plurality of clamping arms includes a clamping terminal. The cylindrical sleeve element is disposed around the clamping element. The cylindrical sleeve element is adapted to move back and forth along the clamping arms thereby adjusting an interval of each two adjacent clamping terminals. The ampoule opener is capable of breaking off ampoules with various calibers due to that the interval between the clamping terminals can be adjusted by moving the cylindrical sleeve element.

### FIELD OF THE INVENTION

The present invention relates to a bottle opener, and more particularly to an ampoule opener.

### BACKGROUND OF THE INVENTION

In clinical situations, ampoule is adapted to load with injection medicines or vitamins. When trying to take or remove medication or prescription drug solution out the ampoule, generally a medical staff needs to break off the head of the ampoule with his/her hands. Because the ampoule is made of glass material in general, the medical staff may have his/her hand wounded by the sharp broken ampoule when using the ampoule. Meanwhile, the medication or prescription drug solution stored in the ampoule may be polluted by the cut/wounding accident.

Conventionally, each ampoule opener is particularly suitable for breaking off the ampoules with one specific caliber. That is, for the ampoules having various calibers, a corresponding number of openers having various openings of different sizes are needed to be prepared; as a result, the budget or cost for the preparedness of the ampoule openers with various openings is relatively high. In addition, it is also time consuming and inconvenient for the medical staff to find the right opener suitable for the ampoule with a specific caliber from a plurality of ampoule openers with various openings.

### SUMMARY OF THE INVENTION

One object of the present invention is to provide an ampoule opener which is capable of breaking off different ampoules configured in a range of various calibers.

The present invention provides an ampoule opener, which includes a clamping element and a cylindrical sleeve element. The clamping element includes a plurality of clamping arms. Each one of the plurality of clamping arms includes a clamping terminal. The cylindrical sleeve element is disposed around the clamping element. The cylindrical sleeve element is adapted to move back and forth along the clamping arms thereby adjusting an interval of each two adjacent clamping terminals.

In an embodiment of the present invention, each one of the plurality of clamping arms includes an adjusting zone. Each one of the plurality of adjusting zones includes the respective clamping terminal, an inner surface and an outer surface opposite to the inner surface. A thickness between the outer surface and the inner surface gradually increases in a direction toward the clamping terminals.

In an embodiment of the present invention, each one of the plurality of inner surfaces is a cambered surface.

In an embodiment of the present invention, each one of the plurality of clamping terminals is disposed with a stopper portion. Each one of the plurality of stopper portions protrudes from the outer surface of the respective clamping arm.

In an embodiment of the present invention, each one of the plurality of clamping terminals is disposed with a clamping portion. Each one of the plurality of the clamping portions protruding from the inner surface of the respective clamping arm.

In an embodiment of the present invention, the ampoule opener further includes a cap. The clamping element further includes a head. The clamping arms extend from the head. The head has a hollow structure and includes an opening. The opening is formed at a top terminal of the head far from the clamping arms. The opening can be covered by the cap.

In an embodiment of the present invention, the head further includes a pivot, and the cap is pin-jointed to the pivot.

In an embodiment of the present invention, the clamping element is made of an elastic material.

In summary, the ampoule opener of the present invention is capable of breaking off ampoules in various calibers and is adapted to solve the conventional problem that users need spend much time to choose a particular ampoule opener which is fit to a specific ampoule. In addition, a set of conventional ampoule openers with various openings can be replaced by one ampoule opener of the present invention; consequentially, the budget or cost for the ampoule openers is down.

### BRIEF DESCRIPTION OF THE DRAWINGS

The invention will become more readily apparent to those ordinarily skilled in the art after reviewing the following detailed description and accompanying drawings, in which:

FIG. 1 is a schematic three-dimensional structural diagram of an ampoule opener in accordance with an embodiment of the present invention;

FIG. 2 is a schematic three-dimensional cross-sectional diagram illustrating an ampoule opener breaking off an ampoule in accordance with an embodiment of the present invention; and

FIG. 3 is a schematic three-dimensional diagram of an ampoule opener with its cap open in accordance with an embodiment of the present invention.

### DETAILED DESCRIPTION OF PREFERRED EMBODIMENTS

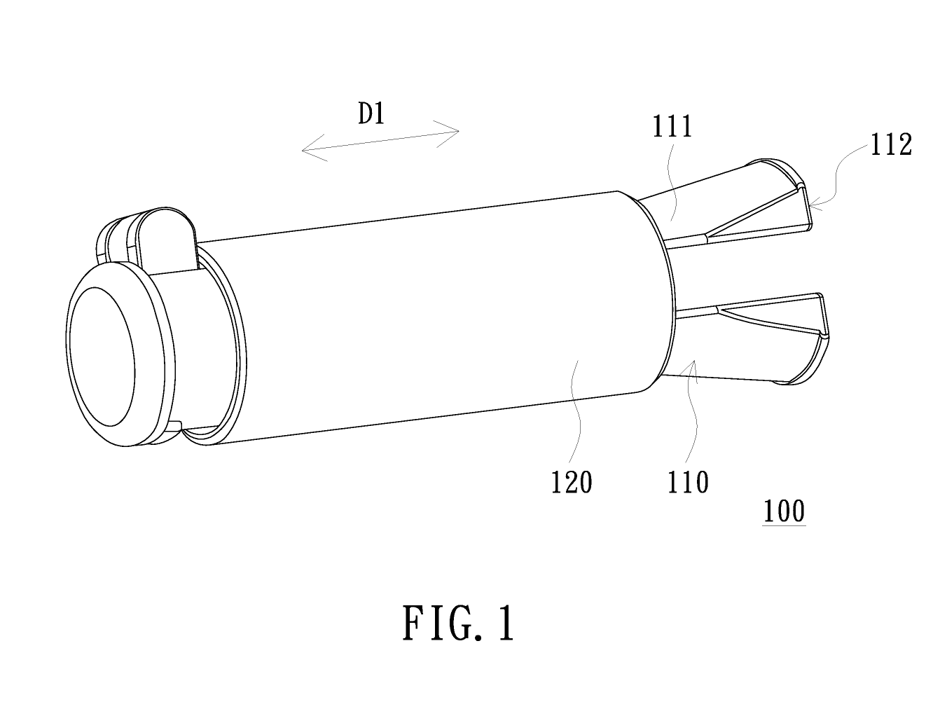

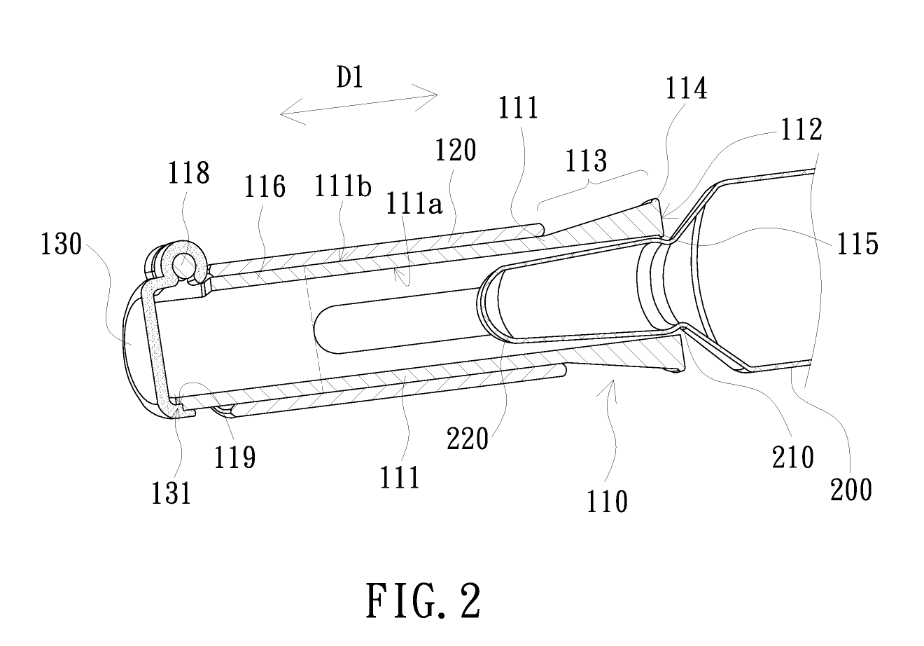

FIG. 1 is a schematic three-dimensional structural diagram of an ampoule opener in accordance with an embodiment of the present invention. Referring to FIG. 1, the ampoule opener 100 in the present embodiment is exemplary for breaking off an ampoule 200 (shown in FIG. 2). However, the ampoule opener 100 may be designed to break off other types of bottles according to specific requirements, and the present invention is not limited thereto. The ampoule opener 100 includes a clamping element 110 and a cylindrical sleeve element 120. The clamping element 110 includes a plurality of clamping arms 111. Each clamping arm 111 has a clamping terminal 112. The cylindrical sleeve element 120 is disposed around the clamping element 110, and is adapted to move back and forth along the clamping arms 111 (for example, along a direction D1) thereby adjusting an interval between each two adjacent clamping terminals 112.

FIG. 2 is a schematic three-dimensional cross-sectional diagram illustrating an ampoule opener breaking off an ampoule in accordance with an embodiment of the present invention. Referring to FIG. 2. In the present illustrated embodiment, each clamping arm 111 has an adjusting zone 113, and each adjusting zone 113 has the above-mentioned clamping terminal 112. In addition, each clamping arm 111 has an inner surface 111a and an outer surface 111b, wherein the outer surface 111b is opposite to the inner surface 111a. For the sake of being corresponding or matching to the shape of the ampoule 200, the inner surface 111a may be a cambered surface in one embodiment thereby having improved clamping effect; however, the present invention is not limited thereto. In the adjusting zone 113 of each clamping arm 111, the thickness between the outer surface 111b and the inner surface 111a gradually increases in a direction toward the respective clamping terminal 112. Specifically, when the cylindrical sleeve element 120 moves toward the clamping terminals 112 (i.e., moves along the direction D1 to the right), the adjusting zones 113 of the clamping arms 111 bend inwards by a push of the cylindrical sleeve element 120. Thus, the interval between each two adjacent clamping terminals 112 of the clamping arms 111 gradually decreases, and a neck 210 of the ampoule 200 is eventually clamped. As a result, a user can make or generate a force to break off the neck 210 of the ampoule 200.

In the present embodiment, the clamping element 110 may be made of elastic material; thus, the adjusting zones 113 of the clamping arms 111 can automatically return or retract back to the preset state by the elastic restoring force once the external force is removed. In addition, when the cylindrical sleeve element 120 moves in a direction opposite to or away from the clamping terminals 112 (i.e., moves along the direction D1 to the left) and away from the adjusting zones 113, the interval between each two adjacent clamping terminals 112 of the clamping arms 111 gradually increases thereby releasing a broken-off head 220 of the ampoule 200 from the clamping terminals 112.

Because being capable of adjusting the interval between each two adjacent clamping terminals 112 through moving the cylindrical sleeve element 120 back and forth along the clamping arms 111, the ampoule opener 100 of the present embodiment is adapted to break off the ampoules 200 in various calibers. Thus, the ampoule opener 100 of the present embodiment can solve the conventional problem relating to users needing or requiring to spend much time to choose a particular ampoule opener which is fit to a specific ampoule. In addition, a set of conventional ampoule openers with various openings can be replaced by just one ampoule opener 100 in this embodiment; and consequentially, the budget or cost for stocking the ampoule openers is lowered.

In this embodiment, the clamping terminal 112 of each clamping arm 111 may be disposed with a stopper portion 114. Each stopper portion 114 protrudes from the outer surface 111b of the respective clamping arm 111. The stopper portions 114 are adapted to stop the cylindrical sleeve element 120 thereby preventing the cylindrical sleeve element 120 from being separated from the clamping element 110 through the clamping terminals 112 when the cylindrical sleeve element 120 is moving toward the clamping terminals 112. The clamping terminal 112 of each clamping arm 111 may be further disposed with a clamping portion 115. Each clamping portion 115 protrudes from the inner surface 111 a of the respective clamping arm 111. The clamping portions 115 are adapted to increase the clamping force so that the neck 210 of the ampoules 200 can be clamped by the clamping portions 115 more firmly.

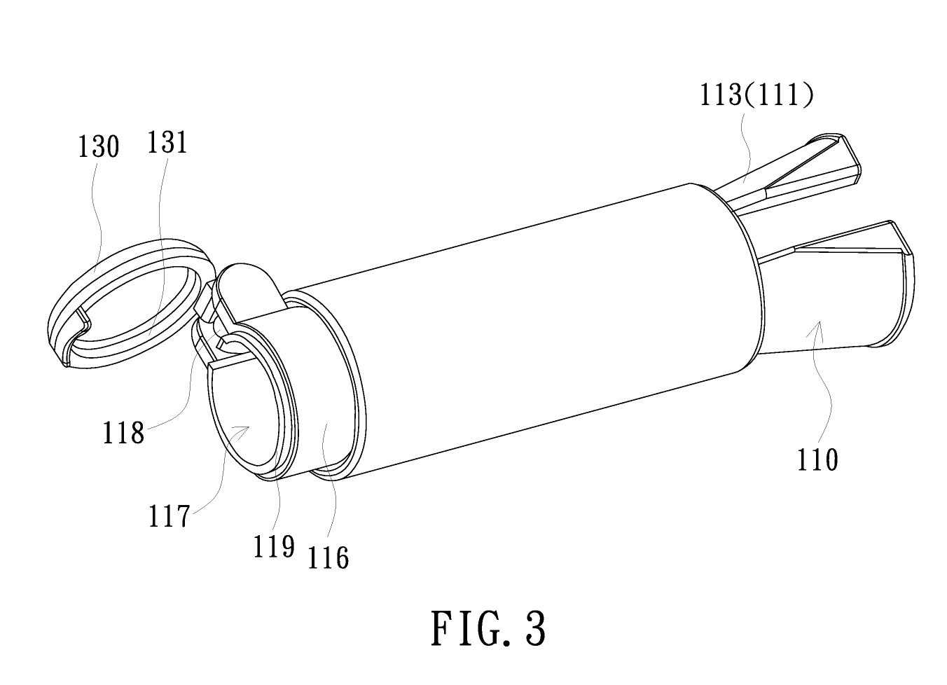

FIG. 3 is a schematic three-dimensional diagram of an ampoule opener with its cap opened in accordance with an embodiment of the present invention. Referring to FIGS. 2 and 3. In this embodiment, the clamping element 110 further has a head 116, and the clamping arms 111 are extended from the head 116. The head 116 has a hollow structure, and is adapted to accommodate the broken-off head 220 of the ampoule 200. The head 116 has an opening 117, which is formed at a top terminal thereof far/distant from the clamping arms 111, wherein the broken-off head 220 of the ampoule 200 can be removed from the ampoule opener 100 through the opening 117.

In addition, the ampoule opener 100 may further include a cap 130. The cap 130 is used to cover the opening 117 so that the broken-off head 220 of the ampoule 200 can be stored in the head 116 of the clamping element 110 without dropping out from the ampoule opener 100. The head 116 of the clamping element 110 may be disposed with a pivot 118, and the cap 130 is pin-jointed to the pivot 118. Thus, through the pivot 118, the cap 130 can be opened or closed relative to the opening 117. Specifically, when the cap 130 is opened (as illustrated in FIG. 3), the broken-off head 220 of the ampoule 200 can be removed from the ampoule opener 100 through the opening 117. In addition, the head 116 of the clamping element 110 may further include a first wedged ring 119; and correspondingly the cap 130 may further include a second wedged ring 131 which is shaped corresponding to the first wedged ring 119. Thus, when the cap 130 covers the head 116 of the clamping element 110, the first wedged ring 119 of the head 116 can be wedged with the second wedged ring 131 of the cap 130, thereby fixing the cap 130 to the head 116 of the clamping element 110.

It is to be noted that the connection means between the cap 130 and the head 116 of the clamping element 110 is not limited in the present invention. In other words, the connection means configured between the cap 130 and the head 116 of the clamping element 110 may be adjusted based on the specific requirements. In addition, it is understood that the head 116 of the clamping element 110 may be disposed without the cap 130; and accordingly, the broken-off head 220 of the ampoule 200 can be removed from the ampoule opener 100 through the clamping terminals 112 directly. That is, the cap 130 may be omitted in another embodiment. In addition, the clamping element 110 illustrated in FIG. 3 is exemplified by including two clamping arms 111; however, the amount or number of the clamping arms 111 is adjustable in response to specific requirements.

In summary, the ampoule opener of the present invention is capable of breaking off ampoules in various calibers and is adapted to solve the conventional problem relating to users requiring to spend much time to choose a particular ampoule opener which is fit to a specific ampoule. In addition, a set of conventional ampoule openers in various openings can be replaced by just one ampoule opener of the present invention; consequentially, the budget or cost for stocking the ampoule openers is down.

The above description is given by way of example, and not limitation. Given the above disclosure, one skilled in the art could devise variations that are within the scope and spirit of the invention disclosed herein, including configurations ways of the recessed portions and materials and/or designs of the attaching structures. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. An ampoule opener, comprising:
a clamping element, comprising a plurality of clamping arms, wherein each one of the plurality of clamping arms comprises a clamping terminal; and
a cylindrical sleeve element, disposed around the clamping element, wherein the cylindrical sleeve element is adapted to move back and forth along the plurality of clamping arms thereby adjusting an interval of each two adjacent clamping terminals.

2. The ampoule opener according to claim 1, wherein each one of the plurality of clamping arms comprises an adjusting zone, each one of the adjusting zone comprises the respective clamping terminal, each one of the clamping arm has an inner surface and an outer surface opposite to the inner surface, a thickness between the outer surface and the inner surface gradually increases in a direction toward the clamping terminals in the adjusting zone.

3. The ampoule opener according to claim 2, wherein each one of the plurality of inner surfaces is a cambered surface.

4. The ampoule opener according to claim 1, wherein each one of the plurality of clamping terminals is disposed with a stopper portion, and each one of the plurality of stopper portions protrudes from the outer surface of the respective clamping arm.

5. The ampoule opener according to claim 1, wherein each one of the plurality of clamping terminals is disposed with a clamping portion, and each one of the plurality of the clamping portions protrudes from the inner surface of the respective clamping arm.

6. The ampoule opener according to claim 1, further comprising a cap, wherein the clamping element further comprises a head, the clamping arms extend from the head, the head has a hollow structure and comprises an opening, the opening of the head is formed at a top terminal of the head far from the clamping arms, the opening is configured to be covered by the cap.

7. The ampoule opener according to claim 6, wherein the head further comprises a pivot, and the cap is pin jointed to the pivot.

8. The ampoule opener according to claim 1, wherein the clamping element is made of an elastic material.
